(19) United States
(12) Patent Application Publication
(10) Pub. No.: US 2026/0352721 A1
(43) Pub. Date: Nov. 5, 2026

(54) Packet Aggregation for Enhanced UE to NTN Voice Operations

(71) Applicant: Apple Inc., Cupertino, CA (US)

(72) Inventors: Fangli XU, Beijing (CN); Chunhai YAO, Beijing (CN); Chunxuan YE, San Diego, CA (US); Dawei ZHANG, Saratoga, CA (US); Haijing HU, Los Gatos, CA (US); Wei ZENG, Saratoga, CA (US); Yuqin CHEN, Beijing (CN)

(21) Appl. No.: 19/118,889

(22) PCT Filed: Oct. 7, 2022
(86) PCT No.: PCT/CN2022/123726

§ 371 Date: Apr. 7, 2025

(51) Int. Cl. H04L 65/65; H04L 65/61

(52) U.S. Cl. CPC H04L 65/65; H04L 65/61

(57) ABSTRACT

A user equipment (UE) is configured to determine a real-time transport protocol (RTP) packet size, determine to aggregate one or more voice packets into an RTP packet based on the RTP packet size, determine a number of the one or more voice packets and transmit the RTP packet comprising the number of the one or more voice packets.

### BACKGROUND

A non-terrestrial network (NTN) refers to a network or a segment of a network that uses an airborne or a spaceborne vehicle for transmission. An NTN may provide an NTN cell, which provides a wider range of coverage than a terrestrial network (TN) cell. In some cases, the coverage area of a single NTN may span across multiple countries.

Compared to TNs, NTNs generally have greater delays, lower throughputs, and larger coverage areas. Despite these tradeoffs, NTNs may be utilized to address mobile broadband and safety needs in areas that are underserved by TNs. It is conceivable that NTNs may be utilized in maritime, aeronautic, railway, and rural/wilderness use cases.

Existing NTNs have poor support for voice services. Enhancements to NTN voice operations are thus needed to improve the mobile broadband and safety experience for users on NTN networks.

### SUMMARY

Some exemplary embodiments are related to a method performed by a user equipment (UE). The method includes determining a real-time transport protocol (RTP) packet size, determining to aggregate one or more voice packets into an RTP packet based on the RTP packet size, determining a number of the one or more voice packets and transmitting the RTP packet comprising the number of the one or more voice packets.

Other exemplary embodiments are related to a method performed by a base station. The method includes exchanging real-time transport protocol (RTP) packets with a user equipment (UE), the RTP packets comprising a voice packet, determining a connection quality of a connection between the UE and the base station and sending a message to the UE including information related to the RTP packets.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows an application layer providing a single voice packet per RTP packet according to various exemplary embodiments.

FIG. 5 shows an application layer aggregating multiple voice packets per each RTP packet according to various exemplary embodiments.

FIG. 6 shows a call flow for an enhanced voice packet scheme for UE to NTN voice operations according to various exemplary embodiments.

### DETAILED DESCRIPTION

The exemplary embodiments may be further understood with reference to the following description and the related appended drawings, wherein like elements are provided with the same reference numerals. The exemplary embodiments relate to enhanced voice operations using aggregated voice packets.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol (e.g., 6G networks, etc.), or any other type of network.

The exemplary embodiments are also described with reference to a voice service of an NTN network. As will be described herein, the aggregating of voice packets may provide advantages in this type of application. However, it should be understood that the exemplary embodiments are not limited to NTN networks. The aggregating of voice packets may be used in any network arrangement.

The exemplary embodiments are related to aggregating voice packets in real-time transport protocol (RTP) packets. As will be described in greater detail below, under certain conditions, a UE and/or a network may aggregate multiple voice packets in each RTP packet. The conditions may be based on a variety of factors including a connection quality between the UE and the network, a transmission interval, a number of repetitions of each RTP packet, etc.

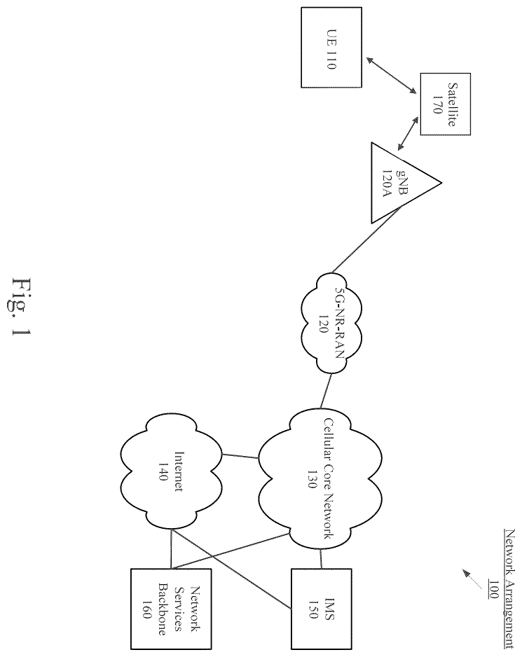

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e. g., 5G cloud RAN, a next generation RAN (NG-RAN), a legacy cellular network, etc. ) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e. g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A.

However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

The UE 110 may connect to the gNB 120A via a satellite 170. The satellite 170 may communicate with the UE 110 via a service link or a wireless interface. The satellite 170 may further communicate with the gNB 120A via a feeder link or a wireless interface. In some embodiments, the satellite 170 may operate as a passive or transparent network relay node between the UE 110 and the gNB 120A. Those skilled in the art will understand that any association procedure may be performed for the satellite 170 to connect to the UE 110 and the gNB 120A.

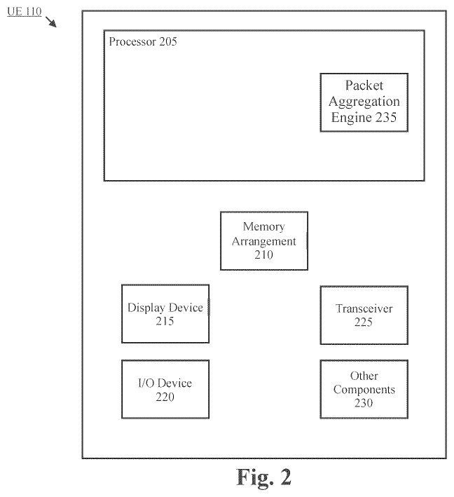

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230.

The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a packet aggregation engine 235 for performing operations such as aggregating voice packets on a per-RTP packet basis for UE to NTN voice operations.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among one or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e. g., set of consecutive frequencies). For example, the transceiver 225 may operate on the unlicensed spectrum when e. g., NR-U is configured.

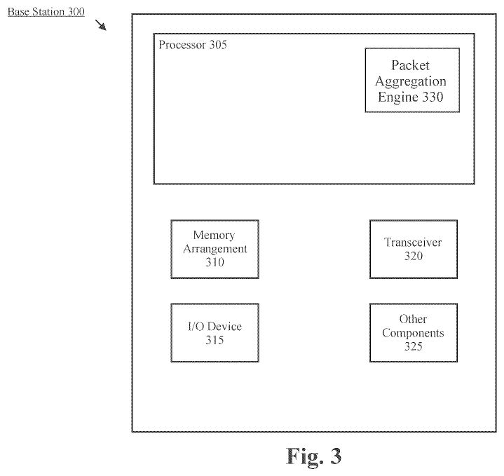

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a packet aggregation engine 330 for performing operations such as aggregating voice packets on a per-RTP packet basis for UE to NTN voice operations.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

There may be various schemes for voice packet transmission in NTNs. The following provides two exemplary schemes for voice packet transmissions.

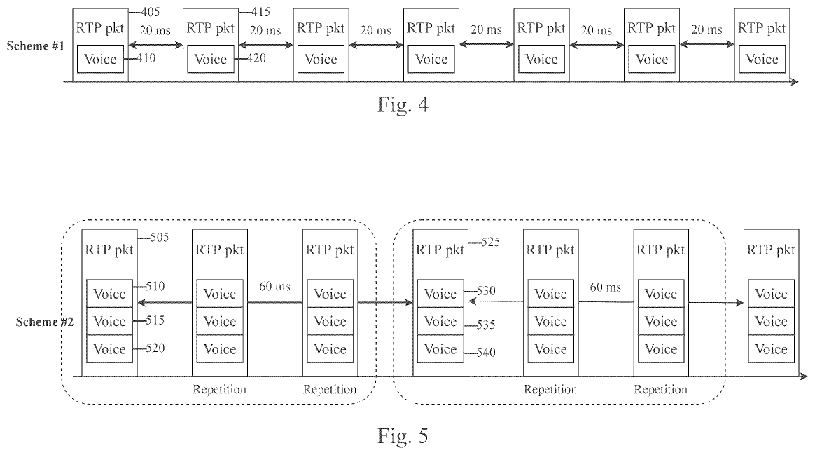

FIG. 4 shows an application layer providing a single voice packet per RTP packet according to various exemplary embodiments. In a first exemplary scheme, an application layer provides a voice packet for each real-time transport protocol (RTP) packet. The RTP layer provides the RTP packet with the RTP type of a single network abstraction layer (NAL) unit packet.

This means the RTP packet includes one voice packet. Thus, in FIG. 4, an RTP packet 405 is shown as including a single voice packet 410. The RTP packet 405 is transmitted. After 20 ms, a second RTP packet 415 including a voice packet 420 is transmitted. This process is repeated every 20 ms until all the voice packets are transmitted. It should be understood that each RTP packet includes a unique voice packet, e.g., the voice packet 410 is different than the voice packet 405.

FIG. 5 shows an application layer aggregating multiple voice packets per each RTP packet according to various exemplary embodiments. In a second exemplary scheme, the application layer may aggregate multiple voice packets for each RTP packet. As will be described in greater detail below, this may result in a longer transmission interval. The RTP layer provides the RTP packet with the RTP type of Aggregation Packet. This means that each RTP packet includes multiple voice packets. In the example of FIG. 5, three voice packets will be aggregated. However, it should be understood that the aggregating of three voice packets in an RTP packet is only exemplary. Other numbers of packets may be aggregated in the RTP packets, e.g., two, four, five, etc.

Thus, in FIG. 5, an RTP packet 505 includes three voice packets 510, 515, and 520. These three voice packets 510, 515 and 520 are transmitted in the RTP packet 505. As shown in FIG. 5, there are optional transmission repetitions for the RTP packet 505. It should be understood that these transmission repetitions are optional because all the data may be successfully transmitted in the initial RTP packet transmission, thereby eliminating the need for a repetition, or in the first repetition, thereby eliminating the need for a second repetition. For example, the PHY repetition transmission may be based on configuration of the gNB and/or L1 scheduling. If the repetition is the HARQ retransmission, the retransmission may be based on whether the previous transport block (TB) is transmitted successfully or not. After 60 ms, a second RTP packet 525 including three voice packets 530, 535, and 540 may be transmitted. This process is repeated every 60 ms until all the voice packets are transmitted.

The two schemes illustrated in FIGS. 4 and 5 may be compared. It may be considered that after 60 ms, each of the schemes has transmitted 3 voice packets. However, the second scheme may have certain advantages over the first scheme. For example, as described above, the longer interval between original packet transmissions in the second scheme allows for a greater number of transmission repetitions which should increase the reliability of the transmissions. In addition, the second scheme may have less overhead than the first scheme. For example, the first scheme requires three RTP packets to transmit the three voice packets. These three RTP packets include three layer 2 (L2) headers and three cyclic redundancy check (CRC). In contrast, if it is considered that the first transmission of the second scheme is successful, only one L2 header and CRC is used to transmit the same three voice packets. This means that if the two schemes are transmitted using the same bitrate, the second exemplary scheme (e. g., aggregating voice packets) may have better transmission performance in the Uu interface.

Thus, in some scenarios, the aggregating of multiple voice packets in a single RTP packet may be the preferred mode of transmission. These scenarios may include the scenario of the UE operating in an NTN network with an active voice call.

However, the application layer is not aware of the radio quality in the Uu interface and cannot adjust the RTP packet type between the single packet and aggregation packet matched to an active Uu radio scenario. The exemplary embodiments provide enhancements to the AS layer to provide assistance information to the application layer and/or RTP layer to adjust the RTP packet type to the active networking scenario.

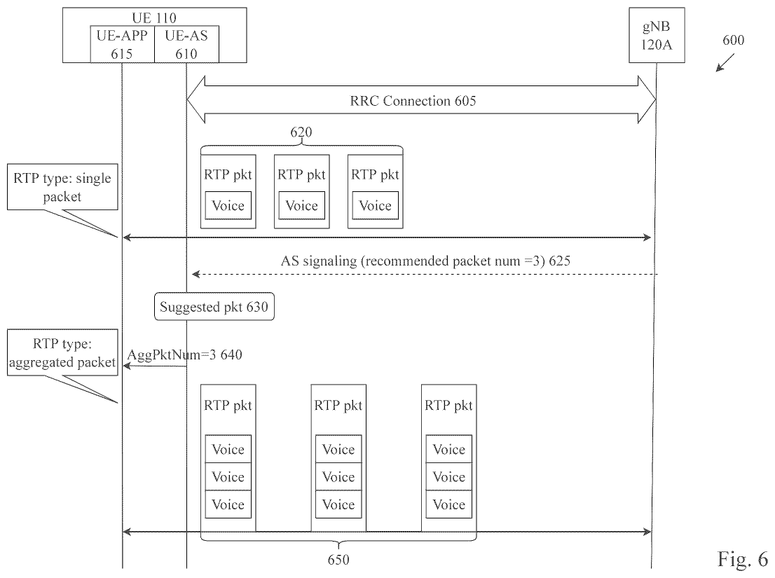

FIG. 6 shows a call flow for an enhanced voice packet scheme for UE to NTN voice operations according to various exemplary embodiments. In the example of FIG. 6, the UE 110 is shown as including an application layer 610 and an access stratum (AS) layer 615. However, it should be understood that the information that is shown as being provided by the AS layer 615 to the application layer 610 may also be provided by the AS layer 615 to the RTP layer.

FIG. 6 also shows the UE 110 communicating with the qNB 120A. However, as described above, the call flow is for UE to NTN voice operations. Thus, it may be considered that the UE 110 has a Uu link to the satellite 170 which also has a link to the gNB 120A. Thus, in this example, the satellite 170 is operating as a transparent relay. However, it should be understood that the exemplary embodiments may be implemented in other types of NTN networks where the satellite is operating in a different manner.

In 605, it may be considered that the UE 110 is operating in radio resource control (RRC) connected mode with the 5G NR-RAN 120 via gNB 120A. It may also be considered that the UE 110 is actively engaged in a voice call, e.g., the UE 110 is exchanging voice packets in the uplink (UL) and downlink (DL) with the gNB 120A.

In 620, this active exchange of voice packets between thew UE 110 and the gNB 120A is illustrated. In this example, the packet exchange in 620 is the first scheme where each RTP packet includes a single voice packet.

In 630, the UE-AS layer 610 may determine that the aggregated type of RTP packet should be used, e.g., RTP packets include multiple voice packets. In 640, the UE-AS layer 610 provides this information to the UE application layer 615. In this example, it is shown that the information provided to the UE application layer 615 is the number of voice packets that should be aggregated, e. g., AggPackNum=3. However, as described in greater detail below, the information is not limited to the specific aggregation number.

The UE AS layer 610 may determine that the RTP packet type should be changed to aggregated type based on various factors. In some exemplary embodiments, the information may be provided by the network, e.g., via gNB 120A). This operation is shown in FIG. 6 as optional operation 625 where the gNB 120A provides a suggested RTP packet size to the UE AS layer 610. As would be understood by those skilled in the art, the network may have information regarding the Uu connection with the UE 110 (e.g., various parameters associated with the connection quality). The network may use this connection information to determine an appropriate RTP packet size to be exchanged over the connection. Other examples of information that the network may use to determine the RTP packet size are described in greater detail below.

In other exemplary embodiments, the UE AS layer 610 may make the determination based on one or more conditions. For example, just as the network may have information on the Uu connection, the UE AS layer 610 may also have information on the connection and use this information to determine whether the RTP packet type should be aggregated. Examples of conditions are provided in greater detail below.

As described above, the UE AS layer 610 may provide the recommended RTP packet size or related information to the application/RTP layer. The UE application/RTP layer may decide whether to aggregate the voice packets together and, if the information does not include an aggregated number, may also determine the aggregated number to form RTP packets.

In a first option, the UE AS layer 610 may provide the UE application layer 615 with an aggregated number of packets based on a current codec mode. For example, the current exchange of packets between the UE 110 and gNB 120A may be based on a currently implemented codec. The UE AS layer 610 may understand the currently implemented codec and determine the number of aggregated packets based on this codec. This information may then be provided to the application layer 615 which may then use the suggested number of aggregated packets for the aggregated RTP packet.

In a second option, the UE AS layer 610 may provide the UE application layer 615 with an aggregated number of packets based on a default codec mode. For example, regardless of the currently implemented codec, the UE AS layer 610 will report the aggregated number of packets for a predefined codec (e.g., 4.75 kbps). When the UE application layer 615 receives the aggregated number of packets from the UE AS layer 610, the UE application layer 615 may understand that the codec mode should be set to the default codec (e.g., 4.75 kbps). Thus, the UE 110 may change the codec mode according to the indicated default mode and the application layer 615 may then use the suggested number of aggregated packets for the aggregated RTP packet.

In a third option, the UE AS layer 610 may provide the UE application layer 615 with an aggregated number of packets and a codec mode. In this option, the UE 110 may change the codec mode based on an indication by the UE AS layer 610 and the application layer 615 may then use the suggested number of aggregated packets for the aggregated RTP packet that corresponds to the suggested coded mode.

In a fourth option, the UE AS layer 610 may provide the UE application layer 615 with an aggregated RTP packet size. In the first three options, the UE AS layer 610 provided the aggregated number of packets. However, in this option, the UE AS layer 610 provides the size of the RTP packet. The UE application layer 615 may then decide the aggregated number of packets on a per RTP packet basis based on a formula. For example, since the UE application layer 615 understands the total size of the RTP packet and the size of the information that will be included in the RTP packet, excluding the voice packets, the UE application layer 615 may calculate the number of voice packets that will fit in the remaining space in the RTP packet, e.g., the aggregated number of packets may be understood to be the (RTP packet size) divided by the (per voice packet size) according to the current codec mode.

Thus, in 650, the RTP layer switches the RTP packet type to an aggregated packet type. The application layer 615 will then provide the number of voice packets corresponding to the aggregated number of packets to be included in the RTP packet. As described above, in this example, the number is three voice packets. The UE 110 will then transmit RTP packets having the aggregated number of voice packets as shown in 650.

In the above examples, it should be understood that the exemplary aggregation of voice packets and all options related to the exemplary aggregation of voice packets may be dedicated for uplink packets, dedicated for downlink packets, or dedicated for both uplink and downlink packets.

As discussed above with respect to 625, the network may provide recommended voice packet information to the UE 110. This recommendation may be based on a scheduling scheme of the network to the UE 110, and may also be based on the current radio connection quality of the UE 110 and the service transmission performance.

The network may provide the voice packet information to the UE 110 via L1/L2/L3 signaling. It should be understood that in the network-recommended packet scheme, all four options described above may be provided by the network and not decided at the UE 110. The network may provide an initial configuration via RRC signaling and may dynamically adjust the voice packet information via L1/L2 signaling. The network may also provide the voice packet information based on a UE request or UE preference, and the UE request may also be transmitted via L1/L2/L3 signaling.

As also described above, the UE AS layer 610 may decide how to handle the recommended voice packet information by itself based on one or more conditions.

In some exemplary embodiments, the condition may be a radio quality threshold. The radio quality threshold may be based on a linkage between the aggregation packet number and the radio quality. For example, if the radio quality of the UE 110 is less than a threshold, the UE 110 may enable the packet aggregation mode and increase the aggregation number. In these exemplary embodiments, the network may configure a mapping between the radio quality threshold, the aggregated packet number and the codec mode. This information may be provided to the UE 110 in the form of a table via any type of signaling with the network, e. g., RRC signaling, a medium access control-control element (MAC-CE), etc. The UE 110 may follow the network-configured mapping table to select the voice packet assembly info (e.g., codec mode, aggregated number of voice packets) based on the quality threshold. However, in other exemplary embodiments, the UE 110 may be provisioned with this threshold information in other manners.

In other exemplary embodiments, the condition may be the transmission interval. This may be based on the linkage between the aggregation packet number and the scheduled transmission interval. For example, if the network provides a configured grant (CG) configuration with a 20 ms interval, the UE 110 will understand that the single packet mode should be used. On the other hand, if the network enables the CG configuration with a 60 ms interval for the voice bearer transmission, the UE 110 will understand that the aggregated packet mode should be used and that the number of aggregated packets is three. The use of the transmission interval can be enabled via the gNB via an RRC configuration, and the network can also configure the reference time interval information (e. g., 20 ms). This reference time interval information may be the interval for single packet mode and then the UE 110 may determine the number of aggregated packets based on the intervals that are multiples of the reference time interval, e.g., 40 ms, 60 ms, 80 ms, etc.

In further exemplary embodiments, the condition may be the transmission repetition number. This may be based on a correlation between the aggregation packet number and the scheduled transmission repetition number. For example, a maximum of 20 repetitions for single packet, 40 repetitions for two aggregated packets, and 60 repetitions for three aggregated packets. This would mean that the aggregated packet number is determined based on the configured maximum repetition.

It should be noted that all the aforementioned conditions may be controlled by the network (e.g., gNB 120A) or controlled based on a UE implementation. It should be further noted that besides the voice aggregated packet number, the condition(s) may also be associated with a particular codec mode.

### EXAMPLES

In a first exemplary embodiments, a processor of a user equipment (UE) is configured to determine a real-time transport protocol (RTP) packet size, determine to aggregate one or more voice packets into an RTP packet based on the RTP packet size, determine a number of the one or more voice packets and transmit the RTP packet comprising the number of the one or more voice packets.

In a second example, the processor of the first example, wherein the RTP packet size is determined by an access stratum (AS) layer of the UE based on a condition.

In a third example, the processor of the second example, wherein the condition comprises a connection quality of a connection between the UE and a network.

In a fourth example, the processor of the third example, wherein the connection quality corresponds to one of (i) the number of the one or more voice packets, (ii) a codec mode for the UE or (iii) the size of the RTP packet.

In a fifth example, the processor of the fourth example, wherein correspondence between the connection quality and the one of (i) the number of the one or more voice packets, (ii) the codec mode for the UE or (iii) the size of the RTP packet is based on information received from the network or information stored in the UE.

In a sixth example, the processor of the second example, wherein the condition comprises a transmission interval between transmitting the RTP packet and a next RTP packet.

In a seventh example, the processor of the second example, wherein the condition comprises a number of repetitions configured for the RTP packet.

In an eighth example, the processor of the first example, wherein the RTP packet size is determined based on an indication received from a network.

In a ninth example, the processor of the eighth example, wherein the indication received from the base station is provided via layer 1 (L1), layer 2 (L2), or layer 3 (L3) signaling.

In a tenth example, the processor of the eighth example, wherein the indication is received based on a UE request or a UE preference.

In an eleventh example, the processor of the first example, wherein the number of the one or more voice packets is based on a codec mode.

In a twelfth example, the processor of the eleventh example, wherein the codec mode is an active codec mode being used by the UE.

In a thirteenth example, the processor of the eleventh example, wherein the codec mode is a default codec mode.

In a fourteenth example, the processor of the eleventh example, the processor further configured to determine the codec mode.

In a fifteenth example, the processor of the first example, wherein the number of the one or more voice packets is based on the RTP packet size.

In a sixteenth example, a user equipment (UE) comprising a transceiver to communicate with a network and the processor of any of the first through fifteenth examples.

In a seventeenth example, a computer readable storage medium comprising a set of instructions that when executed cause the processor to perform the operations of any of the first through fifteenth examples.

In an eighteenth example, a processor of a base station is configured to exchange real-time transport protocol (RTP) packets with a user equipment (UE), the RTP packets comprising a voice packet, determine a connection quality of a connection between the UE and the base station and send a message to the UE including information related to the RTP packets.

In a nineteenth example, the processor of the eighteenth example, wherein the information comprises a recommended number of voice packets to be included in each of the RTP packets.

In a twentieth example, the processor of the eighteenth example, wherein the information comprises a size of the RTP packets.

In a twenty first example, the processor of the eighteenth example, wherein the information comprises a correspondence between a connection quality determined by the UE and one of (i) the number of the one or more voice packets, (ii) a codec mode for the UE or (iii) a size of the RTP packet.

In a twenty second example, the processor of the eighteenth example, wherein the message is one of a layer 1 (L1), layer 2 (L2), or layer 3 (L3).

In a twenty third example, a baser station comprising a transceiver to communicate with a user equipment (UE) and the processor of any of the eighteenth through twenty second examples.

In a twenty fourth example, a computer readable storage medium comprising a set of instructions that when executed cause the processor to perform the operations of any of the eighteenth through twenty second examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
determining a real-time transport protocol (RTP) packet size;
determining to aggregate one or more voice packets into an RTP packet based on the RTP packet size;
determining a number of the one or more voice packets; and
transmitting the RTP packet comprising the number of the one or more voice packets.

2. The method of claim 1, wherein the RTP packet size is determined by an access stratum (AS) layer of the UE based on a condition.

3. The method of claim 2, wherein the condition comprises a connection quality of a connection between the UE and a network.

4. The method of claim 3, wherein the connection quality corresponds to one of (i) the number of the one or more voice packets, (ii) a codec mode for the UE or (iii) the size of the RTP packet.

5. The method of claim 4, wherein correspondence between the connection quality and the one of (i) the number of the one or more voice packets, (ii) the codec mode for the UE or (iii) the size of the RTP packet is based on information received from the network or information stored in the UE.

6. The method of claim 2, wherein the condition comprises a transmission interval between transmitting the RTP packet and a next RTP packet.

7. The method of claim 2, wherein the condition comprises a number of repetitions configured for the RTP packet.

8. The method of claim 1, wherein the RTP packet size is determined based on an indication received from a network.

9. The method of claim 8, wherein the indication received from the network is provided via layer 1 (L1), layer 2 (L2), or layer 3 (L3) signaling.

10. The method of claim 8, wherein the indication is received based on a UE request or a UE preference.

11. The method of claim 1, wherein the number of the one or more voice packets is based on a codec mode.

12. The method of claim 11, wherein the codec mode is an active codec mode being used by the UE.

13. The method of claim 11, wherein the codec mode is a default codec mode.

14. The method of claim 11, further comprising:
determining the codec mode.

15. The method of claim 1, wherein the number of the one or more voice packets is based on the RTP packet size.

16. A method performed by a base station, comprising:
exchanging real-time transport protocol (RTP) packets with a user equipment (UE), the RTP packets comprising a voice packet;
determining a connection quality of a connection between the UE and the base station; and
sending a message to the UE including information related to the RTP packets.

17. The method of claim 16, wherein the information comprises a recommended number of voice packets to be included in each of the RTP packets.

18. The method of claim 16, wherein the information comprises a size of the RTP packets.

19. ) The method of claim 16, wherein the information comprises a correspondence between a connection quality determined by the UE and one of (i) a number of the voice packets included in the RTP packets, (ii) a codec mode for the UE or (iii) a size of the RTP packets.

20. The method of claim 16, wherein the message is one of a layer 1 (L1), layer 2 (L2), or layer 3 (L3).
